(19) United States
(12) Patent Application Publication
(10) Pub. No.: US 2023/0249053 A1
(43) Pub. Date: Aug. 10, 2023

(54) CUE STICK SUPPORT FOR BILLIARDS HAVING IMPROVED GRIP FEELING

(71) Applicant: GO CUE INC., Incheon (KR)

(72) Inventors: Chul Hoon PARK, Incheon (KR); Jae Yong PARK, Incheon (KR)

(73) Assignee: GO CUE INC., Incheon (KR)

(21) Appl. No.: 18/004,726

(22) PCT Filed: Jan. 18, 2021
(86) PCT No.: PCT/KR2021/000692

§ 371 Date: Jan. 9, 2023

(30) Foreign Application Priority Data
Jul. 10, 2020 (KR) 10-2020-0085418

(51) Int. Cl. A63D 15/10; F21V 33/00

(52) U.S. Cl. CPC A63D 15/105; F21V 33/008; A63D 2015/001

(57) ABSTRACT

A cue stick support for billiards, and, more specifically, to a cue stick support for billiards having an improved grip feeling, in which the cue stick support is placed, in a tube shape, between a finger that forms a bridge and a cue stick, to hold and support the cue stick over a wide surface, thereby achieving accurate hitting by allowing the cue stick to easily move only in the forward and backward directions while preventing the cue stick from shaking up and down and left and right during a preparation motion for hitting a cue ball and a hitting motion. In addition, seating indentations are formed at portions on the outer surface of the cue stick support, where the thumb, index and middle fingers are brought into contact when gripping, thereby improving the grip feeling.

### TECHNICAL FIELD

The present disclosure relates to a cue stick support for billiards and, more specifically, to a cue stick support for billiards in which the cue stick support is placed in a tubular shape between fingers that form a bridge and a cue stick to hold and support the cue stick with a wide surface, thereby achieving accurate striking by allowing the cue stick to easily move only in the forward and backward directions while preventing the cue stick from shaking up and down and left and right during a preparation motion for hitting a cue ball and a striking motion. In addition, a seating groove is formed at a portion on the outer surface of the cue stick support where the thumb, index, and middle fingers are brought into contact during gripping, thereby improving a grip feeling. In particular, the present disclosure relates to a cue stick support for billiards having an improved grip feeling, in which a support protrusion in the middle portion and a back-side extension support portion are filled to remove an empty space between the finger that forms a bridge or the palm and the cue stick to prevent the cue stick from shaking due to the empty space, thereby improving the accuracy of hitting the cue ball.

### BACKGROUND ART

In general, billiards is a kind of sport in which players compete for individual scores on a billiards table by hitting a cue ball with a cue stick to make the cue ball collide with an object ball. There are many games in billiards, which may be roughly classified into a carom game, a pocket game, and a snooker game. The carom game includes a 4-ball game, a balkline game, a three-cushion game, and the like.

A cue stick used in a billiards game is a long rod including an upper rod and a lower rod which are coupled to each other, and is mainly made of wood (or an iron material). When playing a billiards game, three or more billiards balls are placed on a billiards table, the billiards balls including a cue ball that is hit with a cue stick, a first object ball and a second object ball that the cue ball collides with while moving, and the like.

In the basic elements of billiards configured as described above, it is important to accurately hit a target point of the cue ball with the cue stick, and to determine how thick the cue ball and the first object ball collide with each other and which direction the hit cue ball moves after the collision.

Among the basic elements of billiards, it is important to make the forward and backward movement of the cue stick on the same straight line during the preparation (stroke) motion before hitting the cue ball and the hitting (shot) motion. However, not only most beginners and middle- and low-level players, but also professional players have a problem in that the cue stick is shaken during the cue stick preparation motion and the striking motion, and the shot is not made to a correct position. That is, a point of the cue stick is fixed by forming a bridge with a hand, but, when the moving path of the hand holding the lower rod of the cue stick shakes, the point of the bridge acts as a hinge point and the cue stick rotates up, down, left, and right.

Korean Patent Laid-Open Publication No. 10-2001-0099201 (published on Nov. 9, 2001 (hereinafter, referred to as “Prior Document 1”)) and Korean Patent No. 10-1759701 (registered on Jul. 13, 2017 (hereinafter, referred to as “Prior Document 2”)) disclose a feature in which a cue stick seating portion is provided on an upper portion of a ring that is put on a finger to stably form the shape of the bridge holding the cue stick, thereby guiding the linear movement of the cue stick forward and backward while preventing the cue stick from shaking left and right.

In the above-mentioned feature, the cue stick is fixed by the ring that is put on the finger, but the ring may be twisted due to a thickness different of fingers between wearers or the pressure on the skin of the finger. Therefore, the ring may swivel left and right even when the ring is firmly worn, and such a swivel movement may cause the cue stick to swivel left and right during the actual cue stick preparation motion or striking motion.

In addition, U.S. Pat. No. 04147346 (published on Apr. 3, 1979 (hereinafter, referred to as “Prior Document 3”)) proposed a cue guide. In Prior Document 3, since a sleeve is provided to cover the cue stick with a wide surface, and a tubular member is vertically installed to the lower portion of the sleeve, the user may grip the tubular member to strongly support the cue stick. Therefore, it is possible to solve the problem that the cue stick shakes left and right due to a gap occurring between the cue stick and the finger forming a bridge for the cue stick. However, according to Prior Document 3, since the cue stick is supported by means of the vertically installed tubular member, the tubular member is not in the form of a normal cue bridge. Thus, it is difficult to use the tubular member for correcting a cue bridge for beginners.

Therefore, there is a demand for a cue stick support that provides a stable cue bridge (billiards bridge) posture and enables precise hitting by preventing a cue stick from rotating up and down and left and right.

### DISCLOSURE OF INVENTION

### Technical Problem

Therefore, the present disclosure provides a cue stick support for billiards having a grip feeling,

in which the cue stick support is formed in a tubular shape surrounding the cue stick and supported by being placed in the fingers forming a bridge, in which a seating groove is formed at portions that are brought into contact with the fingers to improve the grip feeling and minimize discomfort for wearing.

In addition, the present disclosure also provides a device that partially expands the outer surface of a cue stick support to fill empty spaces between a thumb, an index finger, and a middle finger, which form a bridge, and the cue stick so as to fundamentally prevent the occurrence of shaking due to the gap between the cue stick support and the hand, thereby providing a stable supporting force and guiding a correct bridge posture to enable precise hitting.

### Solution to Problem

A The present disclosure provides a cue stick support for billiards that is improved in a grip feeling for solving the above-mentioned problems.

The cue stick support for billiards that supports a cue stick may include: a main body configured in a C-shaped or O-shaped tubular body having a support axial hole into which the cue stick is slidably inserted, wherein the main body has a length penetrating a bridge formed by a hand in a front-back direction; and a seating groove formed on an outer surface of the main body at a portion where a thumb, an index finger, and a middle finger, which are fingers of a wearer’s hand that form the bridge, come into contact to reduce an interval between an inner surface of the support axial hole and the fingers.

The seating groove may include a first seating groove which is brought into contact with inner surfaces of the index finger and the thumb that form a bridge shape, and a second seating groove which is brought into contact with an upper surface of the middle finger that supports a lower portion of the main body.

The first seating groove may have an inner surface that is formed in a curved surface and brought into contact with a metacarpal portion of the index finger including a branch point with the thumb, and the inner surface, which comes into contact with second and third nodes from a tip of the index finger in which proximal phalanges and metacarpals of the index finger are located may be formed as a first bent surface and a second bent surface, which are multi-folded at an angle at which the index finger is bent when forming a bridge, thereby ensuring wearing at a correct position.

The cue stick support for billiards may further include: a protrusion section configured to prevent shaking of the main body by filling a gap between the main body and the fingers forming the bridge on the outer surface of the main body.

The protrusion section may be an expanded support portion that fills a space between a branch point of the thumb and index finger and the main body by increasing a thickness to be biased toward the branch point between the thumb and the index finger forming the bridge on the back side of the main body.

The protrusion section of the main body may be a support protrusion protruding from a middle portion of the main body to a side surface.

Here, the support protrusion may protrude from a side surface of the main body by a short length in a range of 5 to 20 mm, so that, during a bridge forming motion, the support protrusion is disposed in an empty space between the thumb and the middle finger while coming into contact with a palm portion connected to the index finger, thereby preventing the cue stick support from being pushed forward or backward, or the support protrusion may protrude from the side surface of the main body by a long length in a range of 21 to 80 mm to provide a structure capable of being held by the thumb, the middle finger, and the palm, thereby providing a stable grip feeling.

The main body may be formed of rubber or silicone material capable of elastic deformation and restoration when pressed, and a slide plate, which is made of any one of a metal material, a wood material, and a plastic material, may be installed on the inner surface of the support axial hole in order to reduce friction with the cue stick, wherein the slide plate may be provided by radially arranging a plurality of plates elongated in an axial direction, or by arranging one or more C-shaped rings formed along a circumference of the inner surface of the support axial hole in the axial direction.

In addition, a light irradiator including a center indication line marked in parallel to the axial direction of the support axial hole or a light irradiator including a light emitter configured to emit light to be long in the axial direction may be integrally formed on or detachably coupled to the main body.

The light irradiator may include a plurality of light emitters for light irradiation, including a reference light emitter installed on the light irradiator main body and an auxiliary light emitter spaced apart from the light irradiator by a wing so that multiple light beams are emitted forward, wherein the reference light emitter may be configured to emit light in a same direction as the axis of the support axial hole, and the auxiliary light emitter may be configured to emit light in parallel with the light from the reference light emitter at an interval spaced apart from the light from the reference light emitter by a radius or diameter of a billiards ball.

The light emitted forward from the light irradiator may be vertical light having a predetermined vertical length.

The light irradiator main body may include a motor, a gear, and a button, and the motor may be operated by clicking a button to draw out the wing from the light irradiator so as to sequentially provide a plurality of set light emitter intervals.

In addition, the wing is installed to be retractable into the light irradiation main body so that the distance between the reference light emitter and the auxiliary light emitter can be adjusted by manually pulling pushing the wings.

In order to provide information about whether the cue stick is horizontal and information about a moving speed of the cue stick during a cue stick preparation process or a striking process, the main body or the light irradiator may be provided with a measuring sensor, which is represented by a gyro sensor and an acceleration sensor, and an information providing device configured to provide by indicating measured information by a speaker or a light-emitting lamp or by transmitting the measured information to a personal terminal.

### Advantageous Effects of Invention

With the cue stick support for billiards of the present disclosure including the above-described features,

the cue stick support is provided in the form of wrapping a cue stick by being placed in a user’s hand forming a bridge and is provided with a seating groove at a portion that comes into contact with fingers. Thus, it is possible to improve a grip feeling. In addition, the interval between the cue stick and the fingers is reduced by the seating groove, it is possible to minimize discomfort caused by wearing the cue stick support.

In the cue stick support of the present disclosure, the space between the fingers forming the bridge and the cue stick are filled with the extended support portion and the support protrusion of the protrusion section. As a result, it is possible to enable stable forward and backward movement of the cue stick by eliminating the gap in which the cue stick may shake.

In particular, by making the extended support portion fit into an elliptical gap between the index finger and the thumb, the cue stick support can be placed at a correct position only with a motion of gripping the cue stick support, which makes it possible to prevent the inconvenience of horizontal alignment around the axis of the cue stick and to help maintain a stable posture.

In addition, it is possible to provide a device that enables striking of an accurate hitting point through an ergonomic structure capable of forming a bridge without shaking by additionally providing support to the cue stick via a portion that is in contact with the extended support portion.

### BRIEF DESCRIPTION OF DRAWINGS

FIGS. 1A and 1B are perspective views illustrating a cue stick support according to an embodiment of the present disclosure.

FIGS. 2A and 2B are schematic cross-sectional views of an installed example of a slide plate according to the present disclosure taken in directions perpendicular to and parallel to the axis, respectively.

FIG. 3A is a perspective view illustrating a cue stick support provided with a first seating groove and a second seating groove, and FIGS. 3B to 3E are views each illustrating the cue stick support in the worn state.

FIGS. 4A and 4B are views illustrating the worn state of the cue stick support according to the present disclosure, in which the position of an extended support portion when the cue stick support is worn is illustrated.

FIGS. 5A and 5B are views illustrating the worn state of the cue stick support according to the present disclosure, in which the position of a support protrusion when the cue stick support is worn is illustrated.

FIGS. 6A and 6B are schematic views illustrating an embodiment in which a center indication line and a light irradiator are provided on the cue stick support according to the present disclosure.

FIGS. 7A and 7B are schematic views illustrating an arrangement structure when two or three light emitters of the light irradiator according to the present disclosure are provided.

FIGS. 8A and 8B are schematic views illustrating a configuration further including an information providing device in the cue stick support according to the present disclosure.

### BEST MODE FOR CARRYING OUT THE INVENTION

Hereinafter, embodiments of the present disclosure will be described in detail with reference to the accompanying drawings. The present disclosure may be variously modified and may have various modes. Thus, specific embodiments will be exemplified in the drawings, and will be described in detail in the detailed description. However, it should be understood that this is not intended to limit the present disclosure to specific embodiments, and all the modifications, equivalents, and substitutions fall within the spirit and scope of the disclosure. Like reference numerals have been used for like elements throughout the description of each figure. In the accompanying drawings, the dimensions of structures are enlarged or reduced compared to actual sizes for clarity of the present disclosure.

The terms used herein are only used to describe specific embodiments, and are not intended to limit the present disclosure. Singular expressions include plural expressions unless the context clearly dictates otherwise. In the present application, it should be understood that the terms such as “comprise,” “include,” and “have” are intended to indicate the presence of features, numbers, steps, operations, and components described in the specification, and/or combinations thereof, but are not intended to preclude the possibility of presence or addition of one or more other features, numbers, steps, operations, elements, and/or combinations thereof.

Unless defined otherwise, all terms used herein, including technical or scientific terms, have the same meaning as commonly understood by a person ordinarily skilled in the art to which the present disclosure belongs. Terms such as those defined in a commonly used dictionary should be interpreted as having a meaning consistent with the meaning in the context of the related art, and unless explicitly defined in this application, the terms should not to be interpreted in an ideal or overly formal sense.

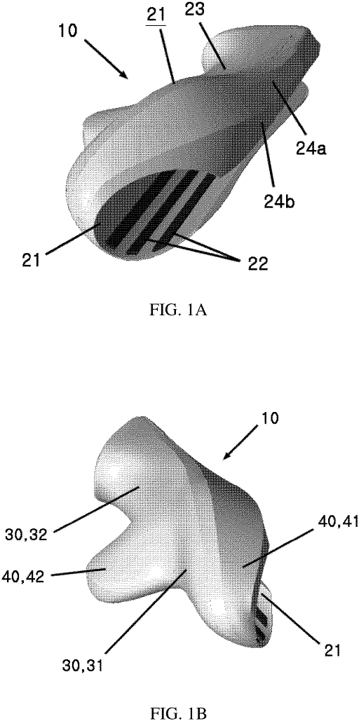

FIGS. 1A and 1B are perspective views illustrating a cue stick support according to the present disclosure.

As mentioned above, a cue stick support 10 according to the present disclosure is configured to allow a user to perform a preparation motion and a striking motion by forming a bridge shape while wrapping the cue stick support with a hand, inserting a cue stick into a support axial hole 21 inside the cue stick support, and moving the cue stick back and forth.

The cue stick support 10 includes a main body 20 provided with the support axial hole 21 into which a cue stick is slidably inserted, and a seating groove 30 which is formed on the outer surface of the main body and in which the fingers forming a bridge are seated.

The main body 20 is a C-shaped or O-shaped tubular body in which the support axial hole 21 is formed to extend forward and backward through a central or laterally deviated portion thereof so that the cue stick is inserted into the support axial hole 21. The cue stick support has a length in the range of 80 to 220 mm in the front-back direction, and protrudes forward and backward by a certain length through the bridge formed by the user to hold the cue stick so that the cue stick support can be supported by the upper portion of the thumb and the upper portion of the middle finger and fixedly pressed by the lower portion of the index finger.

The main body 20 may be made of a rubber material, a silicone material, or the like to improve a tactile or wearing sensation, and various elastically deformable materials may be used so that the inner diameter of the support axial hole can be reduced by a pressing force or can be restored to its original position.

In addition, a slide plate 22 may be installed on the inner surface of the support axial hole 21 to prevent an increase in frictional force with the cue stick due to the material of the main body 20. The slide plate 22 may be made of various materials such as metal, wood, and plastic that are capable of minimizing the frictional force by coming into contact with the cue stick, and is preferably formed of a metal material to reduce the frictional force while preventing wear or damage.

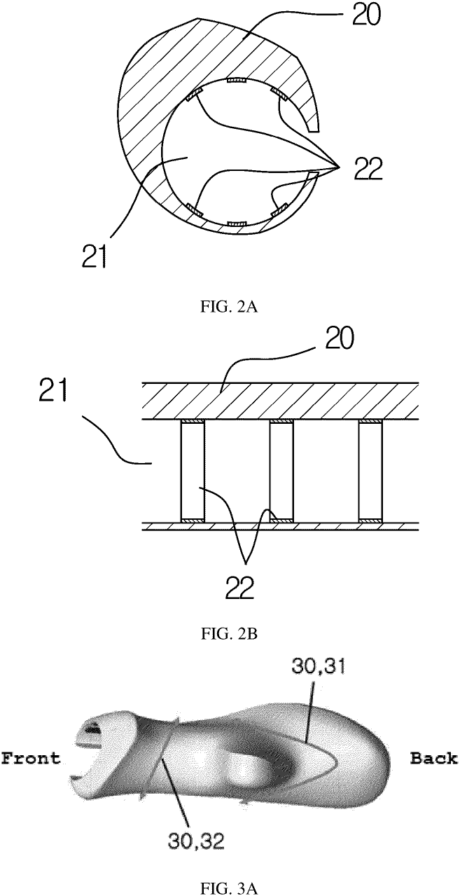

As illustrated in FIG. 2A, a plurality of slide plates 22 are arranged radially around an axis and provided in the form of strips to be elongated forward and backward so that the outer surface of the cue stick only comes into contact the metal slide plates. Alternatively, as illustrated in FIG. 2B, the slide plates 22 may be provided in a C-ring shape and arranged at regular intervals in the longitudinal direction to be capable of partially wrapping and supporting the cue stick. In addition, the slide plate 22 may be provided in various forms while applying a metal material in a manner of minimizing the frictional force between the cue stick and the cue stick support such as forming a metal material or a plating layer on the entire inner surface of the support axial hole to minimize the frictional force.

Next, the seating groove 30 is formed on the outer surface of the main body, and by forming the groove at a portion where the fingers forming a bridge when holding the cue stick support 10 and forming the bridge are brought into contact, especially at a portion that comes into contact with the upper side of the thumb 81 supporting the lower surface of the cue stick support, the lower side of the index finger 82 surrounding the upper portion of the cue stick support, and the upper side of the middle finger 83 supporting the lower surface of the cue stick support, the interval between the fingers forming the bridge and the cue stick is reduced and the inconvenience caused by mounting the cue stick support is minimized.

In addition, it is possible to correct since the position of holding the cue stick with each finger by the seating groove 30, the seating groove 30 may be helpful for beginners to get bridge formation training.

The present disclosure is described based on a right-handed cue stick support. However, a left-handed cue stick support, which is formed symmetrically with the right-handed cue stick support, will fall within the scope of the present disclosure.

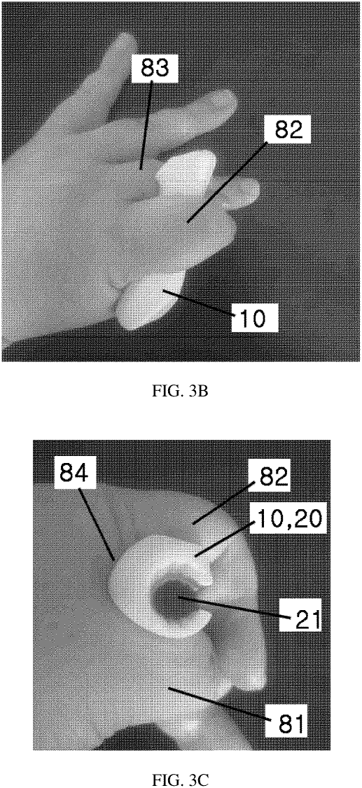

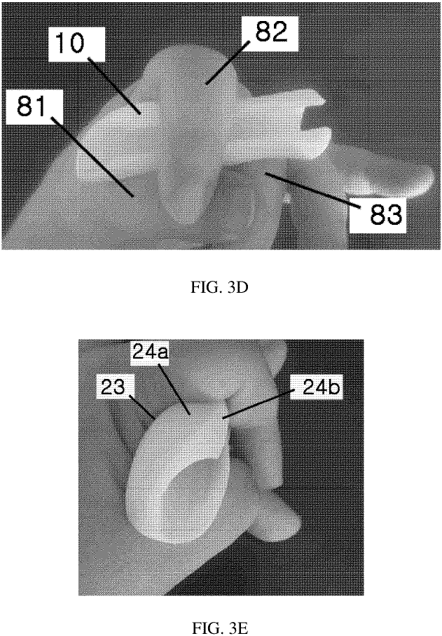

As illustrated in FIG. 3A, the seating groove 30 may be roughly divided into a first seating groove 31 and a second seating groove 32.

Referring to FIGS. 3B to 3D, the first seating groove 31 is a groove formed at a portion where an index finger 82 forming a bridge shape and covering the upper portion of the main body of the cue stick support body and a thumb 81 coming into contact with the lower portion of the main body while supporting the lower portion of the bridge are brought into contact. The first seating groove 31 is formed as a single groove along a line interconnecting the branch point 84 of the thumb 81 and the index finger 82, the upper side of the proximal phalanges of the thumb 81 adjacent to the branch point, and the lower surface of the phalanges of the index finger 82 adjacent to the branch point, so that natural seating is achieved. The first seating groove 31 is formed to intersect the axis of the support axial hole 21 formed in the front-back direction at an angle of 10 to 30 degrees with reference to the axis when viewed from above. The first seating groove 31 is formed from the outer side of the front upper surface through the inner side surface of the back side to the outer side of the front lower surface, thereby surrounding the outer surface of the main body.

The second seating groove 32 is a groove configured such that, of the node of the middle finger 83 corresponding to the proximal phalanges, the side surface and upper surface, which face the index finger, are seated in the groove. The second seating groove 32 is a groove formed on the surface of the main body where the middle finger 83 supporting the lower front side of the cue stick support body is brought into contact so that the middle finger is partially inserted into the groove.

As described above, the seating groove 30 formed by the first seating groove 31 and the second seating groove 32 is processed into a gentle curved surfaces at the boundary with the outer surface of the main body 20 to provide a soft image as a whole. The lowest point of the seating groove 30 is disposed close to the inner surface of the support axial hole 21, so that even when the cue stick support is worn, a feeling of discomfort due to wearing may be reduced since the distance between the cue stick inserted into the support hole and the fingers is small.

As illustrated in FIGS. 1A and 3E, the outer surface of the main body including the first seating groove may be provided with a first bent surface and a second bent surface when viewed in a vertical section orthogonal to the axis. In particular, the inner surface of the first seating groove 31, which comes into contact the metacarpal portion of the index finger including the thumb and branch point, is formed as a curved surface 23, and the inner surface, which comes into contact with the second and third nodes from the tip of the index finger in which the proximal phalanges and metacarpals of the index finger are located is formed as a first bent surface 24a and a second bent surface 24b, which are multi-folded at an angle at which the index finger is bent when forming a bridge, so that when mounting the cue stand support, the curvature of the cue stick support can be naturally arranged in correspondence with the fingers without the need for aligning the center of the cue stick support, thereby implementing center correction. In addition, the inner angle formed by the curved surface and the first bent surface and the inner angle formed by the first bent surface and the second bent surface may be the same as or similar to the inner angle at which the index finger is bent when forming a bridge, so that a comfortable grip can be achieved. Preferably, the inner angle formed by the curved surface and the first bent surface may be in the range of 80 to 100 degrees, and the inner angle formed by the first and second bent surfaces may be in the range of 90 to 140 degrees to provide a comfortable grip feeling and achieve horizontal alignment.

As illustrated in FIGS. 1, the cue stick support 10 for billiards of the present disclosure may further include a protrusion section 40 that partially increases the thickness of the outer wall of the main body while maintaining the axial position of the support through-hole 21 of the main body.

The protrusion section 40 protrudes to eliminate the gap between the fingers forming the bridge and the outer surface of the main body of the cue stick support body 20 in the state in which the cue stick support 10 is mounted. When the gap between the fingers and the outer surface of the main body of the cue stick support is filled and removed, a space in which the cue stick is rotatable left and right or up and down when moving forward and backward is removed from the inside of the hand forming the bridge so that the cue stick can be stably supported. That is, since a finger portion at a position that is not close to the cue stick or the support axial hole is capable of providing a support force to the cue stick through the protrusion, it is possible to prevent shaking of the cue stick by providing an improved support force to the cue stick than a cue stick supporting force provided only by fingers or a cylindrical support.

The protrusion section 40 may be divided into an expanded support portion 41 formed on the back side of the main body and a support protrusion 42 protruding from the intermediate side surface of the main body.

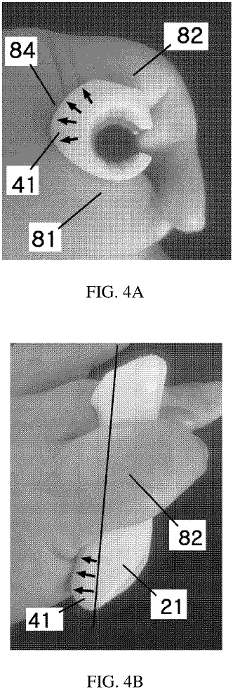

First, as illustrated in FIGS. 4A and 4B, the expanded support portion 41 fills the space between the branch point 84 of the thumb and index finger and the main body 20 by increasing the thickness to be biased toward the branch point 84 between the thumb 81 and the index finger 82 forming the bridge on the back side of the main body.

That is, when a bridge is formed by a hand and the cue stick is inserted into the bridge, a space is formed between the branch point 84 of the thumb and index finger and the cue stick, and the cue stick does not receive a support force from the empty space side. Thus, when the cue stick moves back and forth, the cue stick moves to the empty space side, which becomes one of the causes of shaking the cue stick, making it difficult to strike by the accurate linear movement of the cue stick.

Therefore, when the expanded support portion 41 is provided by expanding the back side portion of the main body 20 to be deviated to one side, the space between the branch point 84 of the thumb and index finger and the cue stick is removed by the expanded support portion, whereby the space in which the cue stick is movable is removed by the expanded support portion. In addition, the supporting force transmitted from the finger branch point to the expanded support portion 41 is transmitted to the cue stick by the integrated configuration to support the cue stick. As a result, it is possible to prevent the cue stick from shaking left and right during the forward and backward movement of the cue stick and to achieve accurate hitting.

In addition, since the expanded support portion 41 is linked to the first seating groove 31, the expanded support portion 41 is expanded in the form of a hook so as to wrap around the branch point 84 of the thumb and index finger in the front-back direction to remove the gap. In addition to removing the gap, the expanded support portion prevents the cue stick support from being pushed forward by the forward and backward movement of the cue stick.

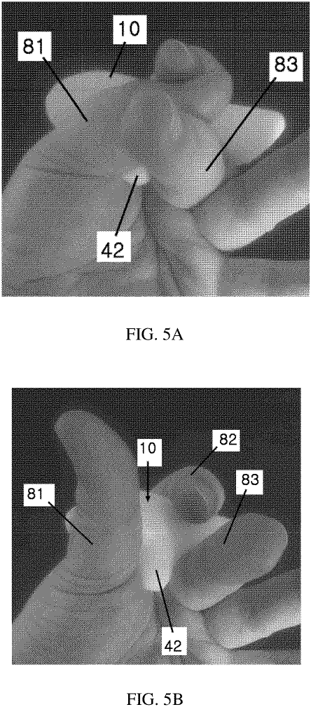

Next, FIG. 5A illustrates the position of the support protrusion when the cue stick support is held normally, and FIG. 5B is a schematic view illustrating the arrangement position of the support protrusion by separating the thumb and the middle finger.

The support protrusion 42 protrudes downward from the side surface of the middle portion of the main body 20, and protrudes inward in contact with the wearer’s palm when the cue stick support is mounted. That is, when forming the bridge shape, the tip of the thumb is fixedly brought into contact with the side surface of the middle finger. At this time, an empty space is formed between the thumb 81 and the middle finger 83, and the support protrusion 42 protrudes into the empty space between the thumb 81 and the middle finger 83. The space between the thumb and the middle finger is a space formed by the nodes or palm where the proximal phalanges of the thumb 81, the metacarpals of the index finger 82, and the proximal phalanges of the middle finger 83 are located.

The support protrusion 42 protrudes only partially to be supported by the thumb 81 and the middle finger 82, or when mounted, the support protrusion 42 protrudes long enough not to touch the billiard table and is wrapped by the palm clenched to form a bridge shape so that stable can be achieved. The support protrusion 42 may be provided in an ergonomic design by, for example, forming the support protrusion to be flexed in a curved shape to come into close contact with the palm while protruding in a conical shape, rather than protruding linearly.

The support protrusion 42 may protrude from the side surface of the main body 20 by a short length in the range of 5 to 20 mm, so that, during a bridge forming motion, the support protrusion 42 is disposed in an empty space between the thumb 81 and the middle finger 83 while coming into contact with the palm portion connected to the index finger 82, thereby preventing the cue stick support from being pushed forward or backward, or the support protrusion 42 may protrude from the side surface of the main body 20 by a long length in the range of 21 to 80 mm to provide a structure capable of being held by the thumb and middle finger and/or the palm, thereby providing a stable grip feeling.

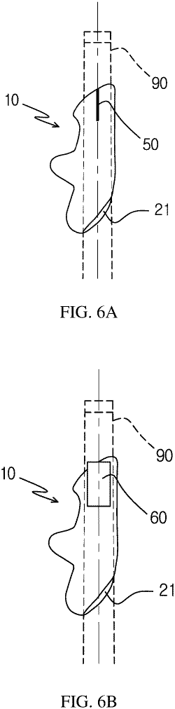

As illustrated in FIG. 6A, the cue stick support 10 of the present disclosure may be marked with a center indication line 50 on the main body in parallel with the axial direction of the support axial hole 21. The center indication line 50 allows a user to check whether the center indication line coincides with the center of the cue stick 90 from the outside, and in the process of making the center mark line coincide with the center of the cue stick, it is possible to accurately correct the position where the cue stick support is held by the fingers.

As illustrated in FIG. 6B, the cue stick support 10 of the present disclosure is provided with a light irradiator 60 on the main body to emit light to be parallel to the cue stick, thereby making it possible to check how thick the cue ball collides with the object ball in front.

The light irradiator 60 may be installed on the upper surface or front end of the main body 20 of the cue stick support so that light is emitted to the front side, or configured and used as a separate attachment/detachment member. As the attachment/detachment method, various methods such as a forward fitting method, a screw coupling method, and a clip-type coupling method may be applied. At this time, the portion where the irradiation light is emitted is placed perpendicularly above the central axis of the cue stick 90 or the central axis of the support axial hole 21 of the cue stick support, so that it is possible to check the correct center line by making light irradiation.

In addition, the irradiation light may travel to a point like a laser point so that a marking can be displayed, or a filter may be installed on the front end of the light irradiator to cause the irradiation light itself to be emitted as vertical light in the up-down direction so that a light marking can be displayed on the cue ball or the object ball in front. In addition, by disposing the irradiation angle of the light irradiator 60 as a predetermined downward angle, it is possible to cause a straight line to be displayed on the billiards table from a portion adjacent to the light irradiator to a position where the cue ball or the object ball is located.

As an example of the configuration of the light irradiator, the light irradiator includes, in the main body thereof, a power supply, a light emitter configured to receive electricity from the power supply to emit light, and a controller configured to control the supply of power and various signals, and while passing through the front filter, the light emitted from the light emitter is converted into vertical light for emitting light.

The light irradiator 60 according to the present disclosure may include one or more light emitters 62 each of which includes a reference light emitter 63 and one or more auxiliary emitters 64, to form a plurality of light beams emitted forward. At this time, the reference light emitter 63 is installed in a light irradiator main body 61 so that light can be emitted in the same direction as the support axial hole 21 or the axis of the cue stick 90, and the auxiliary light emitters 64 may be horizontally spaced apart from the reference light emitter 64 by the radius or diameter of the billiards balls by one or more wings 65 drawn out from the light irradiator main body so that light can be emitted in parallel.

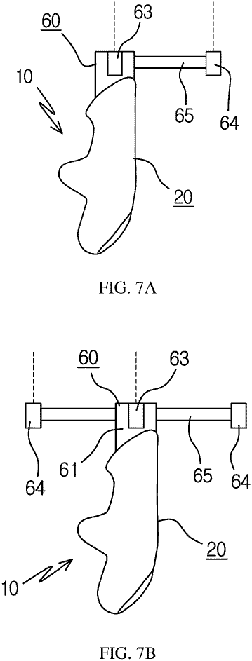

For example, as illustrated in FIG. 7A, the reference light emitter 63 is disposed on the same vertical line as the support axial hole 21 to emit light, and one auxiliary light emitter 64 may emit light at a position horizontally spaced apart from the reference light emitter by the radius or diameter of the billiards balls to emit light in parallel to that from the reference light emitter.

In addition, as illustrated in FIG. 7B, when three light emitters are provided, the reference light emitter 63 is disposed on the same vertical line as the support axial hole 21, and the auxiliary light emitters 64 are disposed on both sides of the reference light emitter, respectively, to make light irradiation in the state of being horizontally spaced apart from the reference light emitter by the radius or diameter of the billiards balls. When the light beams are emitted in parallel to each other as described above, it is possible to check thickness information as to how thick the cue ball, which is hit and moved, collides with the object ball.

In addition, by additionally mounting a filter on each of the reference light emitter 63 and the auxiliary light emitters 64 such that light is emitted in vertical light, it is possible to form a line on the billiards table or a vertical line on a billiards ball to easily check the thickness information.

Here, the light irradiator main body 61 may include a motor, gears, and a button.

The motor is operated by clicking a button to rotate the gear, and the gear is meshed with a wing which is integrally provided with the auxiliary light emitter, so that it is possible to adjust the interval between the reference light emitter and the auxiliary light emitter by moving the auxiliary light emitter. In this case, as the gears, a worm and a worm gear are used, and an additional reduction gear is additionally provided, so that it is possible to finely adjust the interval between the reference light emitter and the auxiliary light emitter. Furthermore, it is possible to adjust the interval between the reference light emitter and the auxiliary light emitter by using various gears. Since the interval adjustment is performed based on values finely set by the controller and the sizes of billiards balls to be used are different depending on the types of billiards games, several stored standardized intervals may be sequentially provided by clicking the button of the light radiator main body. Of course, it is possible to arbitrarily increase or decrease the interval by using one or two buttons.

In addition, the wings may be configured to be manually drawn out from the light irradiation main body. In this case, the interval between the reference light emitter and the auxiliary light emitters may be adjusted by manually pulling or pushing the auxiliary light emitters or the wings.

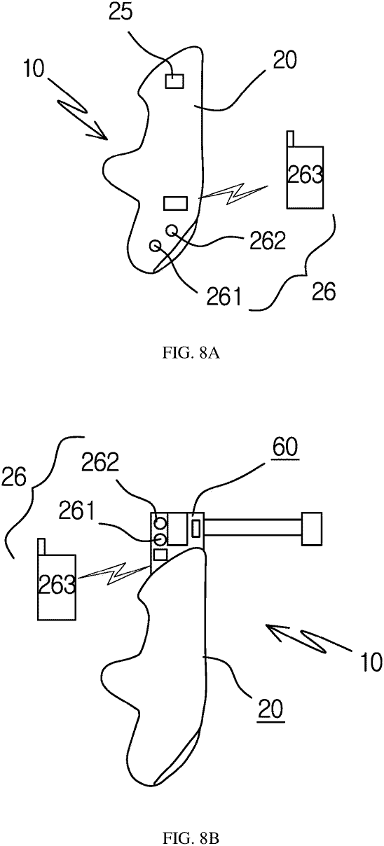

As illustrated in FIGS. 8A and 8B, the main body 20 or the light irradiator 60 of the cue stick support according to the present disclosure may further include a measuring sensor 25 configured to measuring various components, and an information providing device 26 configured to notify the outside of the information measured by the measurement sensor.

Representative examples of the measuring sensor 25 include a gyro sensor configured to measure information about inclination and an acceleration sensor configured to measure information about hitting speed of a cue stick. The measuring sensor is connected to the controller to provide measured information. The gyro sensor is installed inside the main body or the light irradiator, and the acceleration sensor is installed on the inner surface of the supporting axial hole that is brought into contact with the cue stick or on the front side close to the inner surface to measure and provide the moving speed of the cue stick during the striking motion of the cue stick.

The information providing device 26 may typically provide audio information through a speaker 261 and may cause a light-emitting lamp 262 to emit light. That is, when the slope measured by the measuring sensor during the striking motion deviates from a tolerable range, the information providing device 26 may cause the light emitting lamp to emit light or the speaker to output sound to inform that the posture is incorrect, thereby helping to correct the posture.

In addition, the information providing device 26 may further include a communication unit to provide information to a personal terminal 263. That is, information input may be provided to the controller of the cue stick 10 or measured inclination information or speed information of the cue stick is provided to a personal terminal 263 connected by wireless communication so that numerical checking can be made. When information is provided to the personal terminal through such communication, it is possible to check the degree of improvement in posture for each time period. Thus, billiards beginners may feel a sense of accomplishment since it is possible to numerically check the status of posture improvement thereof through practice.

Description of Reference Numerals

| | | | |
|---|---|---|---|
| 10: | cue stick support | | |
| 20: | main body | | |
| 21: | support axial hole, | 22: | slide plate |
| 25: | measuring sensor, | 26: | information providing device |
| 261: | speaker, | 262: | light-emitting lamp |
| 263: | personal terminal | | |
| 30: | seating groove | | |
| 31: | first seating groove, | 32: | second seating groove |
| 40: | protrusion section | | |
| 41: | extended support portion, | 42: | support protrusion |
| 50: | center indication line | | |
| 60: | light irradiator | | |
| 61: | light irradiator main body, | 62: | light emitter |
| 63: | reference light emitter, | 64: | auxiliary light emitter |
| 65: | wing portion | | |
| 80: | hand | | |
| 81: | thumb, | 82: | index finger |
| 83: | middle finger, | 84: | branch point |
| 90: | cue stick | | |

1. A cue stick support for billiards that supports a cue stick, the cue stick support comprising:
a main body configured in a C-shaped or O-shaped tubular body having a support axial hole into which the cue stick is slidably inserted, wherein the main body has a length penetrating a bridge formed by a hand in a front-back direction; and
a seating groove formed on an outer surface of the main body at a portion where a thumb, an index finger, and a middle finger, which are fingers of a wearer’s hand that form the bridge, come into contact to reduce an interval between an inner surface of the support axial hole and the fingers.

2. The cue stick support for billiards of claim 1, wherein the seating groove includes a first seating groove which is brought into contact with inner surfaces of the index finger and the thumb that form a bridge shape, and a second seating groove which is brought into contact with an upper surface of the middle finger that supports a lower portion of the main body.

3. The cue stick support for billiards of claim 2, wherein the first seating groove has an inner surface that is formed in a curved surface and brought into contact with a metacarpal portion of the index finger including a branch point with the thumb, and
the inner surface, which comes into contact with second and third nodes from a tip of the index finger in which proximal phalanges and metacarpals of the index finger are located is formed as a first bent surface and a second bent surface, which are multi-folded at an angle at which the index finger is bent when forming a bridge, thereby ensuring wearing at a correct position.

4. The cue stick support for billiards of claim 1, further comprising:
a protrusion section configured to prevent shaking of the main body by filling a gap between the main body and the fingers forming the bridge on the outer surface of the main body.

5. The cue stick support for billiards of claim 4, wherein the protrusion section is an expanded support portion that fills a space between a branch point of the thumb and index finger and the main body by increasing a thickness to be biased toward the branch point between the thumb and the index finger forming the bridge on the rear side of the main body.

6. The cue stick support for billiards of claim 4, wherein the protrusion section of the main body is a support protrusion protruding from a middle portion of the main body to a side surface.

7. The cue stick support for billiards of claim 6, wherein the support protrusion protrudes from a side surface of the main body by a short length in a range of 5 to 20 mm, so that, during a bridge forming motion, the support protrusion is disposed in an empty space between the thumb and the middle finger while coming into contact with a palm portion connected to the index finger, thereby preventing the cue stick support from being pushed forward or backward, or
the support protrusion protrudes from the side surface of the main body by a long length in a range of 21 to 80 mm to provide a structure capable of being held by the thumb, the middle finger, and the palm, thereby providing a stable grip feeling.

8. The cue stick support for billiards of claim 1, wherein the main body is formed of rubber or silicone material capable of elastic deformation and restoration when pressed, and a slide plate, which is made of any one of a metal material, a wood material, and a plastic material, is installed on an inner surface of the support axial hole in order to reduce friction with the cue stick, wherein the slide plate is provided by radially arranging a plurality of plates elongated in an axial direction, or by arranging one or more C-shaped rings formed along a circumference of the inner surface of the support axial hole in the axial direction.

9. The cue stick support for billiards of claim 1, wherein a light irradiator comprising a center indication line marked in parallel to an axial direction of the support axial hole or a light irradiator comprising a light emitter configured to emit light to be long in the axial direction is integrally formed on or detachably coupled to the main body.

10. The cue stick support for billiards of claim 9, wherein the light irradiator comprises a plurality of light emitters for light irradiation, comprising a reference light emitter installed on the light irradiator main body and an auxiliary light emitter spaced apart from the light irradiator by a wing so that multiple light beams are emitted forward, wherein the reference light emitter is configured to emit light in a same direction as the axis of the support axial hole, and the auxiliary light emitter is configured to emit light in parallel with the light from the reference light emitter at an interval spaced apart from the light from the reference light emitter by a radius or diameter of a billiards ball.

11. The cue stick support for billiards of claim 10, wherein the light emitted forward from the light irradiator is vertical light having a predetermined vertical length.

12. The cue stick support for billiards of claim 10, wherein the light irradiator main body comprises a motor, a gear, and a button, and the motor is operated by clicking a button to draw out the wing from the light irradiator so as to sequentially provide a plurality of set light emitter intervals.

13. The cue stick support for billiards of claim 10, wherein the wing is installed to be retractable into the light irradiator main body so that the interval between the reference light emitter and the auxiliary light emitter is adjusted by manually pulling or pushing the wing.

14. The cue stick support for billiards of claim 9, wherein, in order to provide information about whether the cue stick is horizontal and information about a moving speed of the cue stick during a cue stick preparation process or a striking process, the main body or the light irradiator is provided with a measuring sensor, which is represented by a gyro sensor and an acceleration sensor, and an information providing device configured to provide by indicating measured information by a speaker or a light-emitting lamp or by transmitting the measured information to a personal terminal.
